(19) United States
(12) Patent Application Publication
(10) Pub. No.: US 2004/0240584 A1
(43) Pub. Date: Dec. 2, 2004

(54) Signal processing

(76) Inventors: Steven Antony Meade, Bristol (GB); John Bishop, Bath (GB); Peter Kenington, Chepstow (GB)

Correspondence Address: MENDELSOHN AND ASSOCIATES PC, 1515 MARKET STREET, SUITE 715, PHILADELPHIA, PA, 19102, US

(21) Appl. No.: 10/480,884

(22) PCT Filed: Jun. 11, 2002
(86) PCT No.: PCT/GB02/02684

(30) Foreign Application Priority Data
Jun. 15, 2001 (GB) 0114799.0

(51) Int. Cl. H04K 1/02

(52) U.S. Cl. 375/297

(57) ABSTRACT

The input signal to a digital predistorter (14) is interpolated (28) and frequency converted (36 to 44) to condition it for predistortion. Similar conditioning can be applied to signals in a feed-forward lineariser.

The invention relates to methods of, and apparatus for, conditioning a signal which is later to be operated on by a digital distortion counteracting equipment to correct the output signal of an amplifier (or other signal handling equipment).

It is well known that a real amplifier will not operate perfectly, i.e. it will distort the signal upon which it operates. For example, this distortion can be caused by intermodulation between components of the signal being amplified.

It is known to correct the operation of an amplifier using a digital lineariser which operates in the digital domain on signals connected with the amplifier. Signals to be manipulated by a digital lineariser are represented digitally as a train of numerical samples, and the values of the samples can be adjusted to effect the linearisation.

From one aspect, the invention provides signal conditioning apparatus for conditioning a consequential signal which is to be adjusted by digital distortion counteracting equipment in the digital domain to correct an output signal produced by signal handling equipment in response to an input signal, wherein the signal conditioning apparatus comprises interpolating means for increasing the sampling rate of the consequential signal and frequency conversion means for frequency converting the consequential signal.

The invention also consists in a method of conditioning a consequential signal which is to be adjusted in the digital domain to correct an output signal of a signal handling process in response to an input signal, wherein the method comprises interpolating the consequential signal to increase its sampling rate and frequency converting the consequential signal.

The invention also consists in a signal, processing system comprising signal handling equipment and a correcting arrangement for correcting an output signal which the signal handling equipment produces in response to an input signal, the correcting arrangement comprising digital distortion counteracting equipment for adjusting a consequential signal in the digital domain to correct said output signal and signal conditioning apparatus for conditioning said consequential signal prior to the counteracting equipment, the signal conditioning apparatus comprising interpolating means for increasing the sampling rate of the consequential signal and frequency converting means for frequency converting the consequential signal.

Moreover, the invention consists in a signal processing method of correcting an output signal produced by signal handling equipment in response to an input signal, the method comprising adjusting a consequential signal in the digital domain to correct the output signal, and conditioning the consequential signal prior to its adjustment, wherein the conditioning comprises interpolating the consequential signal to increase its sampling rate and frequency converting the consequential signal.

In preferred embodiments the counteracting equipment is a digital lineariser. In a particularly preferred embodiment, the consequential signal is the input signal to the signal handling equipment and the lineariser is a digital predistorter which adjusts the input signal to eliminate distortion in the output signal. In another embodiment, the lineariser is a feed-forward lineariser and the input signal is sensed to provide the consequential signal, which is then adjusted by the lineariser and combined with the output signal to eliminate distortion in the output signal.

The process of adjusting the consequential signal by the counteracting equipment, for example by generating non-linear components in the consequential signal, to correct the output signal is likely to increase the bandwidth of the consequential signal. The frequency conversion translates the consequential signal to a band centre frequency suited to the performance of the adjustment (e.g. to accommodate increased bandwidth). The interpolation endows the consequential signal with a sampling rate suitable for representing the consequential signal after its adjustment (e.g. to accommodate increased bandwidth).

When the consequential signal is not supplied in digital form, it will need to be converted to the digital domain to permit the adjustment to be performed by the counteracting equipment, and it will usually need to be returned to the analogue domain at some later point. The interpolation process increases the sampling rate of the consequential signal with the result that the sampling rate of the analogue to digital (A-D) conversion technology used to digitise the consequential signal can be lower than that of the digital to analogue (D-A) conversion technology used to return the consequential signal to the analogue domain. This is advantageous for several reasons.

First, the D-A conversion may be required (e.g. due to signal bandwidth) to take place at a sample rate beyond the capabilities of the available A-D technology (the development of A-D technology tends to lag behind that of D-A technology in terms of attaining higher sampling rates). Second, allowing the A-D conversion to take place at a lower sampling rate than the D-A conversion permits a cost reduction in the A-D conversion technology used. Third, in an A-D converter, there is usually a trade-off between the resolution of the digitised signal (i.e. the number of bits used to represent a sample) and sampling rate. By running the A-D conversion technology at a low sampling rate, its resolution can be increased. This is advantageous because enhanced resolution gives enhanced dynamic range and an enhanced signal to noise ratio.

The frequency conversion may be a frequency upeonversion or a frequency downconversion such as a downconversion to baseband. The frequency conversion may render the consequential signal into a quadrature format. The frequency conversion may be performed using a digital oscillator signal. The frequency conversion may be performed using an oscillator signal whose frequency is substantially equal to the band centre frequency of the consequential signal prior to its frequency conversion.

Preferably, the band centre frequency and sampling rate of the consequential signal prior to its interpolation are related such that its band centre frequency is substantially ¼ of its sampling rate. This permits the efficient implementation of filtering to remove image components introduced by the interpolation process. Preferably, the interpolation process doubles the sampling rate of the consequential signal.

In one embodiment, the signal handling equipment may be designed to perform a nominally linear operation on the input signal to produce the output signal (for example, the signal handling equipment may be an amplifier), and the adjustment to the consequential signal may then be for the purpose of linearising the signal handling equipment.

The invention also extends to programs for performing methods according to the invention. Such programs may be kept in a suitable data storage device such as a memory or on a suitable storage medium such as a disk.

By way of example only, certain embodiments of the invention will now be described with reference to the accompanying drawings, in which:

FIG. 1 is a block diagram of a predistortion system;

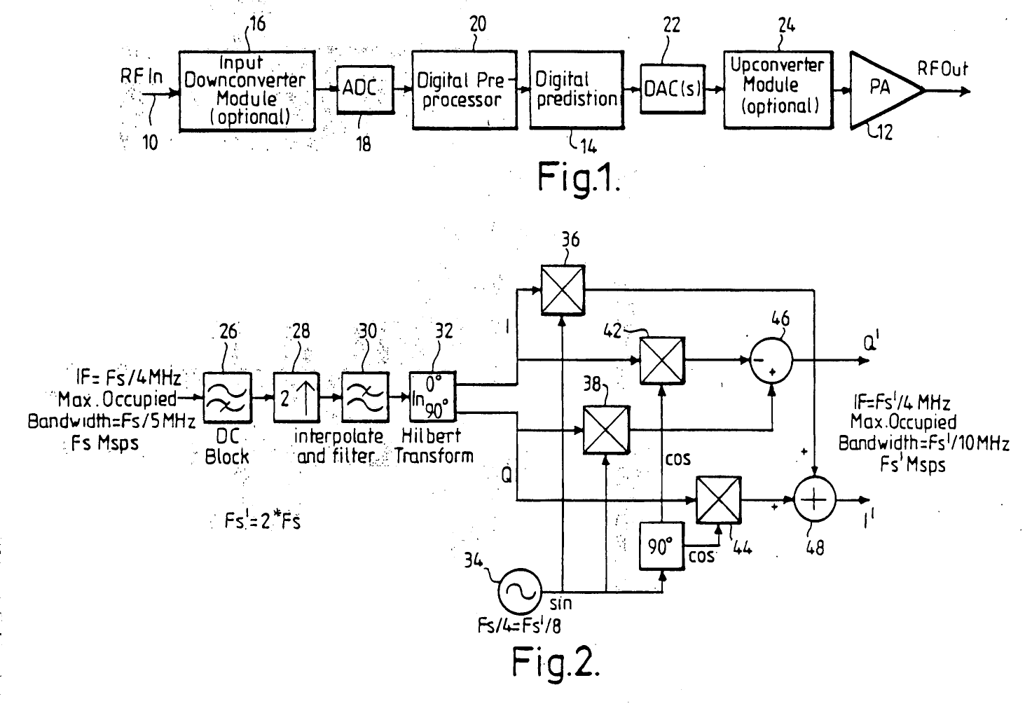

FIG. 2 is a block diagram of a pre-processing stage for a predistortion system;

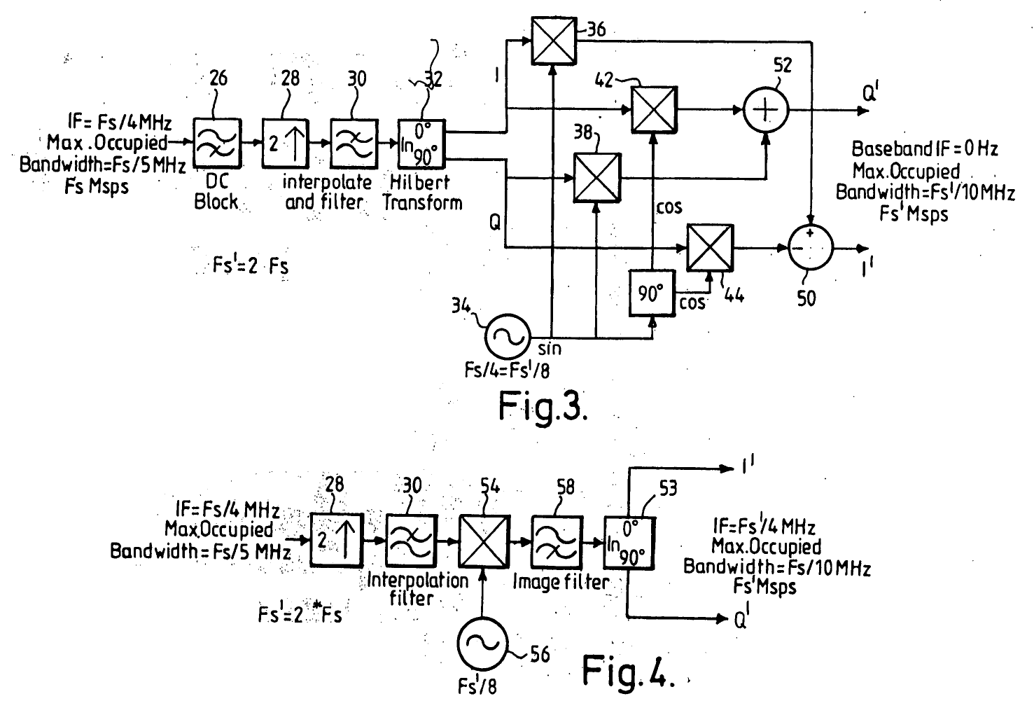

FIG. 3 is a block diagram of another preprocessing stage for a predistortion system;

FIG. 4 is a block diagram of yet another pre-processing stage for a predistortion system; and

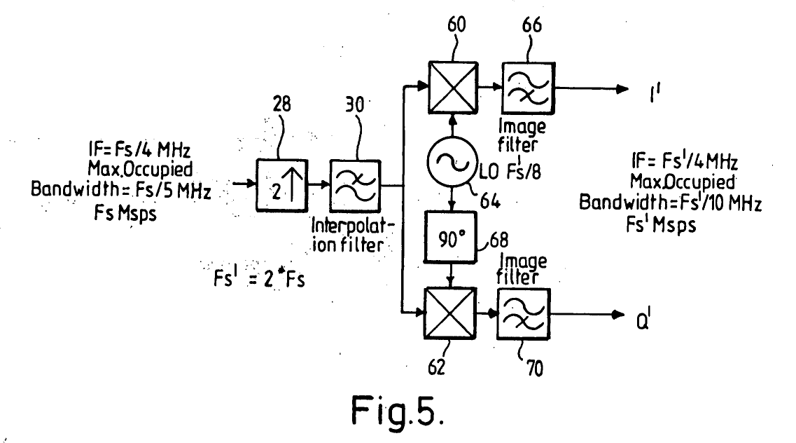

FIG. 5 is a block diagram of another pre-processing stage for a predistortion system.

The predistortion system of FIG. 1 operates on the input signal 10 to a radio frequency power amplifier (RFPA) 12. The pedistortion 14 is performed in the digital domain. As shown in FIG. 1, the input signal is a RF (radio frequency) signal comprising an occupied frequency band and this is downconverted 16 in frequency before being supplied to an ADC 18 (analogue to digital converter). The downconversion 16 is performed to translate the input signal to a band centre frequency which is supported by the sampling rate of the ADC 18. The input signal 10 could be supplied as a digital signal, thus removing the need for ADC 18. The digital input signal is supplied from ADC 18 to digital pre-processor 20 which conditions the signal before it undergoes digital predistortion 14. The digitally predistorted signal is then supplied to DAC (digital to analogue converter) 22 for conversion for the analogue domain. The analogue predistorted signal output by DAC 22 is then upconverted 24 to a desired band centre frequency and supplied to the RFPA 12. Where the output of the DAC 22 is at the desired band centre frequency, upconversion 24 is unnecessary.

FIG. 2 illustrates a possible form of the digital pre-processing stage 20. A DC blocking process 26 is initially performed on the digital input signal which removes any DC component of the digital input signal and passes the wanted input signal band around the input IF (intermediate frequency). If the input signal is provided at baseband, then DC component removal cannot be effected simply by a DC blocking process. The digital amplifier input signal is then subject to interpolation 28 by a factor of 2 in order to double its sampling rate. The interpolated signal is then filtered 30 to remove image components introduced by the interpolation process. The filtering process 30 can be implemented efficiently by arranging that the input signal supplied to the pre-processing stage has a band centre frequency which is one quarter of its (pre-interpolation) sampling rate. The filtering process 30 can then be implemented as a low-pass half-band filter whilst still maintaining the desired pass band ripple and stop band attenuation. A real-time half-band filter uses relatively few multiplication and summation processes, thus permitting a cost effective implementation.

A hilbert transform 32 is then performed on the amplifier input signal to render it into quadrature format comprising I and Q components. A digital oscillator signal is created by a digital oscillator process 34 and this is used to upconvert the quadrature signal IQ to quadrature signal I′Q′. The I and Q outputs of the hilbert transformation 32 each have a band centre frequency of ⅛ of the sampling rate of the interpolated signal. The local oscillator signal output by oscillator process 34 has the same frequency as the band centre frequency of, and the sampling rate as the, output of the interpolator 28. The output of oscillator process 34 is supplied to multiplier processes 36 and 38. The output of the oscillator process 34 is phase shifted by 90° and supplied to multiplier processes 40 and 42. multipliers 36 and 42 also receive the I component produced by hilbert transform 32, and multipliers 38 and 44 receive the Q component output by hilbert transform 32. The outputs of multipliers 38 and 42 are combined at subtractor 46 to produce component Q′ of the uprconverted signal and the outputs of multipliers 36 and 44 are combined in adder 48 to produce component I′ of the upconverted signal. The components I′ and Q′ each have a band centre frequency of ¼ of the sampling rate of the interpolated signal, i.e. the band centre frequency of the amplifier input signal has been doubled compared to its pre-interpolation frequency. The frequency increase is an integer multiple of the sampling rate which means that the digital oscillator signal can be implemented as a simple repeated sequence because there is an integer number of samples per cycle in the oscillator signal. The components I′ and Q′ are then supplied to the digital predistortion process 14.

FIG. 3 illustrates an alternative architecture for the pre-processing stage 20. The pre-processing stage shown in FIG. 3 differs from that of FIG. 2 in that the outputs of the multipliers 36, 38, 42 and 44 are handled differently. The outputs of multipliers 36 and 44 are combined at subtractor 50 to produce component I′ and the outputs of multipliers 38 and 42 are combined at adder 52 to produce component Q′. The result of this change to the manipulation of the outputs of the multiplier processes 36 to 44 is that the signal represented by the quadrature components I′ and Q′ is at baseband. This allows the digital predistortion process 14 to work with baseband signals.

FIG. 4 shows a further alternative architecture for the pre-processing stage 20. The pre-processing stage shown in FIG. 4 operates in the same way as the pre-processing stages shown in FIGS. 2 and 3 up to the post interpolation filtering process 30 (note that the DC blocking process is not shown in FIG. 4). The architecture of FIG. 4 differs from that of FIGS. 2 and 3 in that the hilbert transform 53 follows, rather than precedes, the upconversion of the amplifier input signal. The upconversion is achieved using a simple, real (as opposed to complex, i.e. I and Q) multiplication process 54. The multiplication process 54 multiplies together the output of the filtering process 30 and the output of a digital oscillator process 56. The output of oscillator process 56 has the same frequency as the band centre frequency of the output of the interpolation filtering process 30, i.e. ¼ of the sampling rate of the signal supplied to. the interpolation process. The output of multiplier process 54 is high-pass filtered 58 to select the double-frequency , image. The′output of the filtering process 58 is supplied to the hilbert transform 53 to produce a quadrature format signal comprising components I′ and Q′ with band centre frequencies at twice the band centre frequency of the pre-interpolation signal. The advantage of this architecture is that the frequency conversion is simple in that it involves only one multiplier. Further, the order of the hilbert transform can be reduced by approximately half. The disadvantage of this architecture over that shown in FIG. 2 is that image filtering process 58 is required. If the downstream predistorter operates on baseband I and Q signals then the image filtering process 58 can be adjusted to be low-pass to select the baseband image.

FIG. 5 shows yet another alternative architecture for the pre-processing stage 20 (note that the DC blocking process is not shown). The main difference between the architecture of FIG. 5 and that of FIGS. 2, 3 and 4 is the absence of the hilbert transform and the complex frequency conversion. This means that the pre-processing stage is simpler. In the FIG. 5 architecture, the output of the interpolation filtering process 30 is supplied to each of two multipliers 60 and 62. Multiplier 60 multiplies the output of interpolation filtering process 30 with the output of a digital oscillator 64 operating at the same frequency as the band centre frequency of the signal supplied to the interpolation process. The output of multiplier 60 is supplied to image filtering process 66 which selects the high frequency image in the output of multiplier 60 to form the I′ component of the upconverted, quadrature amplifier input signal. The output of the digital oscillator 64 is phase shifted 68 by 90° and supplied to multiplier 62 where it is multiplied with the output of the interpolation filtering process 30. The output of multiplier 62 is supplied to image filtering process 70 which selects the high frequency image of the output of multiplier 62 to form the Q′ component,of the upconverted, quadrature amplifier input signal destined for the predistortion process. The image filtering processes 66 and 70 can be adjusted to be low-pass to select the baseband images in their inputs ′if the downstream predistorter operates on baseband signals.

1. Signal conditioning apparatus for conditioning a consequential signal which is to be adjusted by digital distortion counteracting equipment in the digital domain to correct an output signal produced by signal handling equipment in response to an input signal, wherein the signal conditioning apparatus comprises interpolating means for increasing the sampling rate of the consequential signal and frequency conversion means for frequency converting the consequential signal.

2-27. (canceled)
